(19) United States
(12) Patent Application Publication
(10) Pub. No.: US 2015/0062346 A1
(43) Pub. Date: Mar. 5, 2015

(54) MOBILE THERMAL IMAGING DEVICE

(71) Applicant: Jacob Fraden, San Diego, CA (US)

(72) Inventor: Jacob Fraden, San Diego, CA (US)

(21) Appl. No.: 14/017,717

(22) Filed: Sep. 4, 2013

(51) Int. Cl. H04N 5/232; G01J 5/10; H04N 5/33; G01J 5/02

(52) U.S. Cl. CPC H04N 5/23267; G01J 5/0265; G01J 5/10; H04N 5/33; H04N 5/23258; G01J 2005/0077
USPC 348/164

(57) ABSTRACT

A mobile noncontact thermal imaging camera employs a stabilization module that detects stability of the received image and provides correction to the detected thermal signals. The stabilization improves sharpness of the thermal image by adjusting signal at the output means and improves noise reduction by processing signals from the pixels corresponding to a particular part of the object image. The stabilization module may have various embodiments, including an accelerometer or a visible video camera having an overlapping field of view with a thermal camera. The invention is applicable to both—the multi-pixel thermal imagers and single-pixel IR thermometers.

This application claims the priority of provisional U.S. patent application Ser. No. 61/698,696 filed on 9 Sep. 2012. The disclosure of the prior related application is hereby fully incorporated by reference herein.

### FIELD OF INVENTION

This invention relates to thermal imaging devices, or more specifically to handheld devices for receiving thermal radiation and converting it to a visible image.

### DESCRIPTION OF PRIOR ART

All objects emit a certain amount of infrared radiation as function of their surface temperatures. Generally speaking, the higher the object's temperature the more infrared (IR) radiation is emitted. Generating of a thermal image by a thermographic camera (TC) is well known in art. It is exemplified by U.S. Pat. No. 6,144,031 issued to Herring et al. that is incorporated herewith as a reference. TC detects the IR radiation in a way similar to an ordinary photo or video camera (VC) that is, electromagnetic radiation in a visible spectrum. A TC is a device that forms a visible image from invisible infrared radiation. Instead of the 450-750 nanometer range typical for the VC (visible range), the TC operates in longer wavelengths—typically from 3,000 nm to as long as 14,000 nm (14 μm) which is called mid- and far-IR or “thermal IR radiation”. A TC works even in total darkness because visible light level does not matter and is outside of capabilities of its optical and sensing components.

A typical TC consists of five essential components: an optical system, detector, amplifier, signal processing, and display (output device). The optical system focuses the thermal IR image on the sensing elements (pixels) of a thermal IR detector that generates electrical signal. The signal is amplified and processed to convert the invisible IR image into a visible image on the display, often by assigning false colors to specific object temperatures. For use in temperature measurement, the brightest (warmest) parts of the image are customarily colored white, intermediate temperatures—reds and yellows, and the dimmest (coolest) parts are blue. On the output device (display, e.g.), a scale should be shown next to a false color image to relate colors to temperatures. An example of a thermal imaging camera for a temperature screening is a U.S. patent publication No. US 2007/0153871 A1 issued to Fraden, that is incorporated herewith as a reference.

A resolution of a TC is substantially lower than that of the VCs. Often it has no more than 160×120 or 320×240 pixels. That is, less than 77 kilopixels as opposed to several megapixels in a typical VC. Further, a single-pixel TC is the most popular IR detecting device that is known as an infrared thermometer or IRT. All IRTs use either pyroelectric or thermopile detectors as exemplified by the U.S. Pat. No. 4,797,840 issued to Fraden, the patent being incorporated herein as a reference. All imaging TCs use detectors that are divided into cooled (the detector is cryogenically cooled to reduce intrinsic noise) and uncooled (the detector is at ambient temperature). Due to a small optical coupling between the object and the detector, in uncooled detectors the temperature differences at the sensor pixels are minute; a 1° C. difference at the scene induces just a 0.03° C. or smaller difference at the sensor. The pixel response time is also fairly slow, in the range of tens of milliseconds.

An imaging TC resembles a VC in its top-level operation: it takes a series of snapshots or frames at a fixed rate. When a portable handheld TC is aimed at a steady object, it is nearly impossible to hold it in a hand perfectly steady that the image would remain unchanged from frame to frame as it would be the case when a tripod is employed. The image jitter is resulted from a natural tremor of the operator's hands or from the object motions. Further, when a relatively long exposure for each frame is used and the object moves, likely a single frame is composed of pixels that do not receive a steady photon flow over the time of the exposure. This leads to a blurry image. A blurry image further degrades a low-resolution image (fewer pixels). This especially is pronounced in TCs having a smaller optical system (a lens, e.g.) that collect less light. Thus, a signal-to-noise ratio at a sensor's pixel level is degraded which results in a noisy image. An example of a small lens in a TC is in a thermal imaging camera installed into a mobile communication device (a smartphone, e.g.).

To reduce noise, electrical signal may be subjected to special processing, for example, to averaging of frames during a specific time interval. This averaging while slowing down the TC camera operation, may significantly reduce noise. Yet, averaging of signals from a pixel loses its advantage if the pixel receives IR radiation from an unsteady object, that is, either from a moving object or a camera jitter while held by hands. Various solutions have been proposed to improve the TC image stability, such as a mechanical damping system as exemplified by the U.S. Pat. No. 7,767,963 issued to Fujii, that is incorporated herein as a reference.

Energy of a photon in the thermal IR spectral range is about 20 times smaller than in the visible range, thus the thermal detectors are much more susceptible to noise. Therefore, in many a TC and IRT, a longer exposure is often desirable to collect more photons and thus enhance the detector's response. Yet, as indicated above, a longer exposure suffers from the image jitter that should be compensated for.

In video and photo cameras, a technique of compensating the image jitter is called “digital image stabilization” (DIS). It's routinely employed in various camera designs and is well known in art. The DIS can be implemented in many versions, depending on the camera complexity and purpose (see for example www.dailyburrito.com/projects/DigitalImageStabilization.pdf). DIS usually produces high quality results in a VC whose images comprise millions of pixels. As a rule, DIS efficiency depends on the number of analyzed pixels. Unfortunately, in a TC a number of pixels is much smaller than in the VC. In fact, it can be as small as just one pixel (in the IRT), thus the algorithms employed in DIS are not effective and thus not practical for use in the TC or IRT.

The DIS for a VC image is a well developed art. The task of the DIS processing is to remove the involuntary image movement caused by, for example, unstable handshaking or vibration. This typically can be implemented in several versions that include shifting of an image sensor, shifting of an optical element in a lens and digital correction of the detected and converted signal. Using a DIS in a TS is much more difficult due to a several factors: larger lens sizes, larger detectors and a comparatively low spatial resolution.

Thus, it is an object of the present invention to provide a device that can stabilize the IR signal received by an IR detector.

It is another object to reduce effect of an IR image jitter on the signal processing;

And another goal of the present invention is to reduce noise in the detected IR signal.

Further and additional objects are apparent from the following discussion of the present invention and the preferred embodiments.

### SUMMARY OF THE INVENTION

This patent teaches design and methods of reducing influence of instability of a thermal camera on the image quality. In one embodiment it is achieved by taking simultaneous images of the same object by both the thermal camera (TC) and visible or near-infrared camera (VC) having overlapping fields of view. An image from the VC is analyzed for shifts and a corrective signal related to the shift value and direction is generated. The signal is used for correcting the image processing from a TC. Another embodiments include a gyroscope or accelerometer to generate a corrective signal to an image produced by the TC.

### BRIEF DESCRIPTION OF DRAWINGS

FIG. 1 illustrates a block-diagram of a thermal camera (TC) with a jitter correction;

FIG. 2 is a symbol for an accelerometer transducer used for jitter compensation;

FIG. 3 is a symbol for a video camera (VC) used for jitter compensation;

FIG. 4 shows overlapping fields of view of a TS and VC installed on a common base;

FIG. 5 illustrates the image shift in both the TC and VC;

FIG. 6 shows a partial pixel shift;

FIG. 7 illustrates a shift of a single-pixel TC field of view within the VC field of view;

FIG. 8 is a timing diagram of a signal from a single TC pixel with two types of averaging.

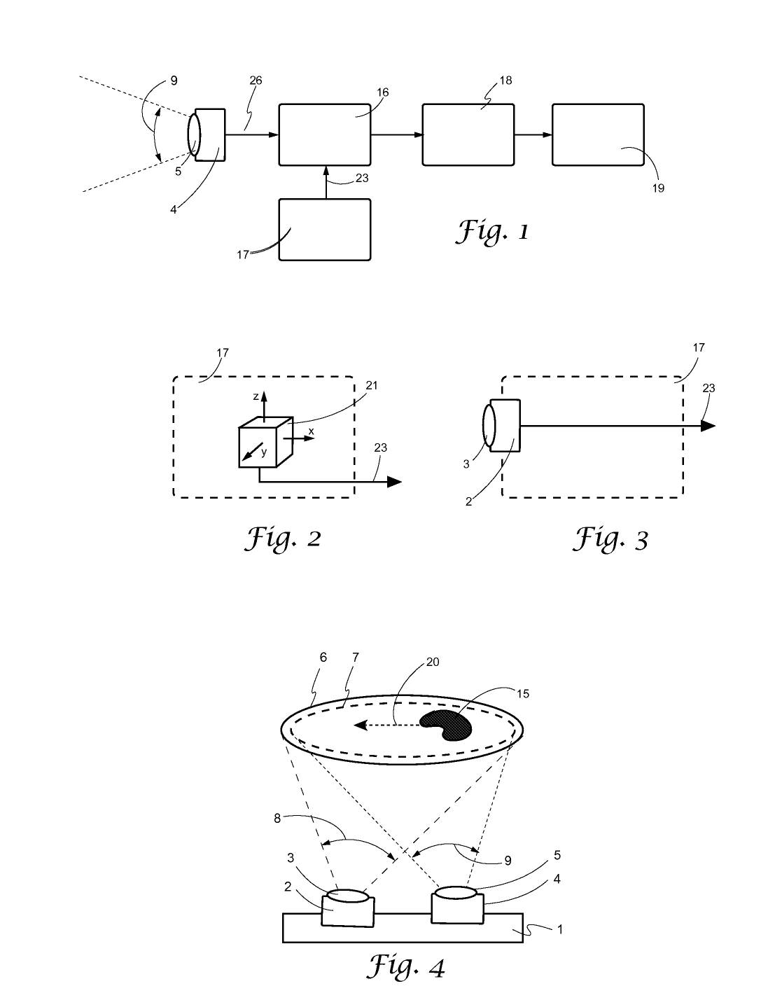

Parts List for FIGS. 1-8

| | |
|---|---|
| 1 | base |
| 2 | VC |
| 3 | VC lens |
| 4 | TC |
| 5 | TC lens |
| 6 | VC field of view |
| 7 | TC field of view |
| 8 | VC angle of view |
| 9 | TC angle of view |
| 10 | frame |
| 11 | VC pixel in a frame |
| 12 | first single-pixel FOV |
| 13 | second single-pixel FOV |
| 14 | VC pixel |
| 15 | object |
| 16 | compensating module |
| 17 | shift detector |
| 18 | image processor |
| 19 | output device |
| 20 | shift direction |
| 21 | accelerometer |
| 22 | shifted single-pixel |
| 23 | compensating signal |
| 24 | weighted averaged signal |
| 25 | unstable signal |
| 26 | original image |
| 27 | averaged signal |
| 28 | shifted image pixel |
| 29 | ideal signal |
| 30 | zero pixel |
| 31 | first pixel |
| 32 | second pixel |
| 33 | third pixel |
| 34 | fourth pixel |
| 35 | fraction of a pixel |

### DESCRIPTION OF PREFERRED EMBODIMENTS

In the foregoing description we use word “jitter” that means “irregular and unsteady motion”. The purpose of the embodiments of this invention is to reduce effects of “jitter” on quality of signals measured by a TC. FIG. 1 illustrates a block diagram of a thermal imaging device with image stabilization. On the front end of the device, there is a thermal camera (TC), 4, with the lens, 5, that is adapted for operation in the range of thermal radiations, typically from 4 to 15 μm of the wavelength. The lens, 5, has an angle of view 9. The TC, 4, may contain a multi-pixel thermal to detector of any conventional design known in art, for example, microbolometers or thermopiles. If the device is an infrared thermometer (IRT), then there may be just a single-pixel detector, such as a thermopile, pyroelectric or bolometer. The thermal image signal, 26, from TC, 4, goes to the jitter compensating module, 16, that also receives a jitter compensating signal, 23, from the shift detector, 17. The compensating module, 16, negates or minimizes effects of jitter in the image formed at the detector of the TC, 4, and passes a corrected signal to the image processor, 18, that manipulates the image in one of the conventional ways known in art. The result of the image processing is presented on the output device, 19, that may be, for example, a display. While items 4, 5, and 17, as a rule, require specialized hardware, functions of items, 16 and 18, may be implemented in a software.

There are several ways of designing the shift detector, 17. One is to incorporate into it a gyroscope or accelerometer, 21, that may be sensitive to motions along the x, y and z axes and also to rotations (FIG. 2). The output signal, 23, carries information about the camera jitter as detected by the accelerometer, 21. Many a smartphones and tablets incorporate accelerometers and, if a TS is incorporated in such a device, the accelerometer can be used for image stabilization. The module, 16, shall be adapted for operation with a particular type of the shift detector, 17.

Another embodiment of the shift detector, 17, is incorporation into it a digital image camera (VC), 2, operating in a visible and/or near IR spectral range (FIG. 3), in other words, covering wavelengths in the range up to 1 micrometer or less. The camera has a lens 3 that operates in the visible and/or near IR spectral range. A VC, 2, is much more sensitive and has a much higher spatial resolution than the TC, 4. It should be noted, however, that a VC will not work in total darkness, unless an auxiliary illuminator is employed (not shown in FIG. 3). Such illuminator (light source) may operate in a visible or near IR spectral range. If an illuminator is not desirable or can't be used for security reasons, e.g., the method shown in FIG. 2 should be used instead.

FIG. 4 illustrates a block-diagram of a thermal imaging camera constructed according to the present invention. Base, 1, carries both the VC, 2, and TC, 4, disposed in a mutual proximity and aimed at the same object, 15. The VC and TC have the corresponding angles of view, 8 and 9, that form the fields of view, 6 and 7, respectively. Note that the VC field of view, 6, is generally larger than the TC field of view, 7, and both fields of view are overlapping.

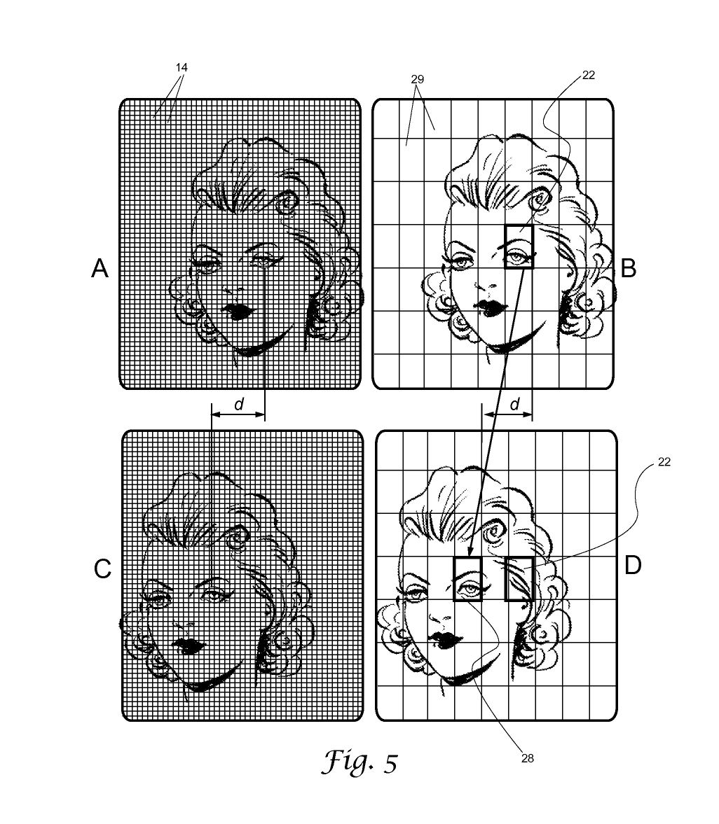

Due to the device jitter or the object movement, the respective images of the object, 15, registered by the TC 4 and VC 2 will be shifted from frame to frame in the direction 20. Regarding the number of pixels, a shift for the same distance “d” will be different in the TC and VC because a VC has far more many pixels, 14, than the TS pixels, 29 (FIG. 5), although the pixels 29 are larger in size than pixels 14. For example, a TC image may shift for two pixels while the VC image shifts for 50 pixels. This is illustrated in FIG. 5 where the first (original) frames, A and B, are formed by the VC and TC respectively. The following frames, C and D, show the image shifts for a distance, d, with respect to the original frames, A and B. It can be appreciated that the B and D images from TC are coarse due to a smaller number of pixels. A VC images A and C will be shifted for a relatively large number of pixels for the same shift distance “d”, while TC images of the same object portion (and eye in the example) will shift from pixel, 22 to pixel 28, that my be rather close to one another. Methods of measurement of jitter in a digital VC image is well known in art and thus not described here in detail.

Image Correction

A shift dᵢ for each frame i first should be measured by one of the methods described above. In other words, it may be computed from the signal generated by the accelerometer, 21, or from a digital image of VC, 2. This correcting signal representing the shift, d, (separately for each axis) can be used to shift the converted thermal image on the output device. 19, thus making it appear steady with less jitter and less blur. This method of shifting the TC pixels in response to the accelerometer, 21, or in relation to shifting the VC pixels can significantly enhance the displayed image quality.

Besides shifting pixels in the outputs device for steadying the image, to reduce noise a TC signal, processing may involve averaging of signals from the same pixel from frame to frame. However, for a simple averaging the result will be rather poor since the same pixel of various frames receives the IR radiation from different parts of the object. For example, such an averaging of a signal from the pixel, 22, will include a signal from an eye (FIG. 5B) in the original frame and a signal from a hairline (FIG. 5D) in the next frame (FIG. 5D), thus the result of averaging will produce a blurry thermal image. If a jitter correction is employed, it would be desirable to average an original pixel, 22, from FIG. 5B and a different pixel, 28, from FIG. 5D because they receive the IR radiation from about the same portion of the object (an “eye”). To determine which pixels in each frame to use in averaging, a value of the shift “d” must be determined first. This function is performed by the shift detector 17 of either design shown in FIG. 2 or FIG. 3.

In the case when a longer exposure of a frame in the output means 19 is desirable, the TC and VC images still should be taken with a relatively fast frame rate, for example 32 frames per second (fps) for a further reduction. In the image processor 18, several frames should be averaged to reduce the displayed rate, for example from 32 to 8 fps, that is, by averaging n=4 sequential frames. Theoretically, this will reduce noise by 2 times. As indicated above, the averaging will be done on signals from the appropriate pixels that are selected according to the shift value dᵢ. A shift value dᵢ for each frame must be known from the shift detector, 17, for each direction of the shift.

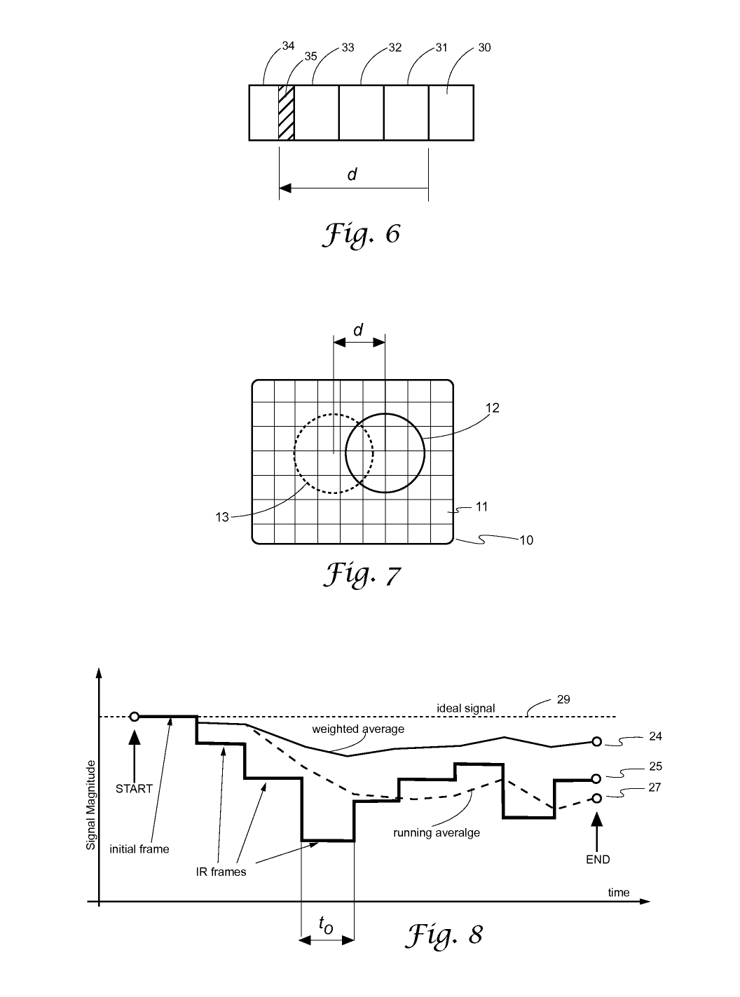

In cases, when the computed shift dᵢ corresponds not to a whole number of the TC pixels, but rather to a whole number plus a fraction, for example to 3.4, the value of the detected photon flux that should be entered into the averaging computation, may be computed by anticipating a correct flux in that particular location. Estimation (anticipation) may be performed by several methods, for example from a linear extrapolation of signals from the neighboring TC pixels. This is illustrated in FIG. 6 where the distance d from pixel 30 includes pixels 31, 32, 33 and a portion 35 of pixel 34. When averaging, signals from pixels 31, 32, 33 should be used along with am adjusted signal from pixel 34 that is computed as an interpolation of pixels, 33 and 34, according to the width of portion, 35.

IRT Correction

If the device is an infrared non-contact thermometer (IRT) being, for example, part of a smart telephone, either a built-in digital camera or imbedded accelerometer can provide correction for the jitter. As a rule, an IRT has only one pixel and thus the pixel shift as described above can't be employed. A mechanical shift of the focusing lens or shift of am IR detector also may be employed, but these solutions are rather cumbersome and expensive at the modern state of art and thus are not described here, however they are the embodiments of this invention. Below we consider a digital correction of the received IR signal.

Temperature measurement by a mobile communication device (smartphone, e.g.) is typically done from a forehead of a patient. An optical system of an IR sensor (lens 5) that is either imbedded into a smart phone or an external case (jacket) as a rule has a relatively narrow angle of view (20° of a solid angle, e.g.), thus it collects the IR photon flux that is substantially weaker if it were collected from a wider angle, say 60°. A smaller photon flux received from a narrow field of view means a diminished signal-to-noise ratio and thus an increased error of measurement. Even if the IR sensor response time is on the order of 10 ms, it would be highly desirable to conduct a measurement for a much longer time, for example 1 s to collect more IR photons in order to improve accuracy. For a mobile device IRT that is intended for a noncontact measurement of temperatures from an object surface, an uncontrollable hand tremor results in a random modulation of the photon flux.

Since the IRT detector as a rule comprises a single IR sensing pixel, a digital pixel shift technique as described above for the image correction can't be employed. Thus other methods of the jitter correction should be employed. In the following embodiment, a long exposure (t₀=1 s, e.g.) of an IR sensitive pixel is replaced by a series of shorter exposures (t₀=118 s, e.g.)—the frames. FIG. 7 illustrates a first single pixel field of view (FOV), 12, in the initial location within the frame, 10, that also comprises the FOV of the VC pixels, 11. When the IRT or the object moves, the IR FOV shifts to a new location, becoming a second single-pixel FOV, 13, by a distance d that is recorded by the subsequent frame. If the entire area of the frame, 10, has a uniform temperature, shifting of the IR FOV would cause no problems for averaging of several snapshots (frames)—the useful IR signal will remain unchanged while noise will be reduced in the averaged signal. In the most practical cases this is just not the case and the larger d, the higher a chance that a new location, 13, will deviate in temperature farther from that in the original location, 12. Thus FOVs, 12 and 13 will collect IR radiation from surfaces of different temperatures.

FIG. 8 illustrates a timing diagram of the detected IR signal, 25, from frame to frame. For the object of a uniform temperature, the ideal signal from frame to frame is represented by a flat line, 29. For an object having variable surface temperature, a photon flax is represented by a step function, 25, reflecting temperature variations as detected by the IRT sensor. The farther the temperature from the first frame temperature (START), the further each step from the ideal signal. A running averaging for the noise reduction would produce a changing signal shown by a dotted line, 27. It is clear that the averaged line, 27, may be positioned far from the ideal signal, 29. For a strong jitter, the error caused by the detected surface temperature variations will be much stronger than the intrinsic IR sensor noise and thus a simple averaging will cause more damage than good. On the other hand, for a small jitter when the temperature deviations are small, averaging could be beneficial. To take into an account the magnitude of a jitter, value d should be measured first and then used as a controlling factor in the averaging computation.

For example, the following formula can be used for averaging signals from different frames:

$${V}_{av} = \frac{1}{n} {\sum }_{0}^{n} [ {V}_{i} + ( {V}_{0} - {V}_{i} ) \frac{{d}_{i}}{{d}_{max}} ] , \qquad ( 1 )$$

where i is the frame number, n is total number of averaged frames, V₀ is the IR signal from the initial frame, dᵢ is a shift of the i frame and dₘₐₓ is the maximum permissible shift. Any shift greater than dₘₐₓ is considered dₘₐₓ.

It follows from the formula that for very small shifts (dᵢ→0), all frames will be nearly equally averaged. However, for a frame that deviates far (large d) from the initial frame (i=0), the contribution to the averaging will be very small. This technique is called a “weighted” averaging and its running value is illustrated by the line, 24, that is positioned closer to the ideal line, 29. Naturally, for a very shaky camera the averaging efficiency for a noise reduction will be diminished, but for a small jitter it will reduce noise significantly.

While the invention has been particularly shown and described with reference to a number of preferred embodiments thereof, it will be understood by those skilled in the art that various changes in form and details may be made therein without departing from the spirit and scope of the invention.

1. A thermal radiation device intended for receiving thermal radiation originated in an object not being part of the thermal radiation device, comprising a thermal radiation sensor generating a first signal in response to the thermal radiation, a thermal radiation optical system having the first field of view, a signal processor and output device, further comprising
a monitor being responsive to a mutual disposition of the thermal radiation device and the object and generating a second signal in relationship to the disposition, wherein the first signal and the second signal are being coupled to the signal processor.

2. A thermal radiation device of claim 1, wherein said monitor comprises a gyroscope.

3. A thermal radiation detecting device of claim 1, wherein said monitor comprises an accelerometer responsive to motion along at least one axis or at least one rotation.

4. A thermal radiation device of claim 1, wherein said monitor comprises a digital imaging camera having a second filed of view and containing a multi-pixel imaging sensor responsive to electromagnetic radiation substantially in the visible spectral range.

5. A thermal radiation device of claim 1, wherein said signal processor is capable of averaging signals received from the monitor.

6. A thermal radiation device of claim 4, wherein the first and second fields of view at least partially overlap.

7. Method of improving quality of an image generated by a thermal imaging camera, such camera containing a thermal radiation sensor generating a first signal, a signal processor and an output device, comprising the steps of:
providing a monitor capable of responding to movements of the thermal imaging camera and capable of generating a second signal, representative of the movements;
providing a compensating module capable of receiving the first signal and the second signal, correcting the first signal by the second signal to reduce errors resulted from the movements and generating a third signal for coupling to said output device.

8. Method of improving quality of an image of claim 7, comprising a further step of providing the monitor with an imaging camera operating in the spectral range not exceeding 1 micrometer of wavelengths.

9. Method of improving quality of an image of claim 7, comprising a further step of providing the monitor with an accelerometer.

10. Thermal imaging camera having a first field of view and comprising a first sensor generating a first signal in response to thermal radiation being emanated by an external object, a signal processor and an output device, further comprising:
a digital imaging camera having a second field of view operating substantially in the visible spectral range and generating a second signal in response to a non-thermal radiation received from the object and generating a second signal,
wherein the signal processor is adapted for receiving the first signal and the second signal and modifying the first signal by the second signal and generating the third signal that is fed to the output device for displaying a thermal image of the object.

11. Thermal imaging camera of claim 10 wherein the first field of view and the second field of view are substantially equal to one another.

12. Thermal imaging camera of claim 10 wherein the first sensor and the digital imaging camera are disposed in a close proximity to one another.
